(19) United States
(12) Patent Application Publication
(10) Pub. No.: US 2007/0159298 A1
(43) Pub. Date: Jul. 12, 2007

(54) System and method for interrogating and updating electronic shelf labels

(75) Inventors: Chris Zegelin, San Jose, CA (US); Vinh-Phuong Tra Le, San Marco, CA (US)

Correspondence Address: BAKER BOTTS L.L.P., 30 ROCKEFELLER PLAZA, 44TH FLOOR, NEW YORK, NY, 10112-4498, US

(73) Assignee: Symbol Technologies, Inc.

(21) Appl. No.: 11/324,717

(22) Filed: Jan. 3, 2006

(51) Int. Cl. G05B 19/00

(52) U.S. Cl. 340/5.91; 340/10.51; 235/385; 340/572.1

(57) ABSTRACT

The present invention describes a system for interrogating or updating electronic shelf tags in a store or warehouse without the need for a complicated or expensive infrastructure. In the system, a single portable RFID device is carried by a worker to perform tasks such as organizing goods on the shelves of a store or a warehouse. As the worker traverses the aisles he may use the portable RFID device to scan each RFID tag as it comes within range. Through a wireless connection to a central controller on which pricing information is stored, the portable RFID device is able to verify that the information located in each RFID tag is correct. If the information is not correct, it can be updated with the correct information from the central controller. Alternatively, the RFID device may be self-contained and have all the correct pricing information stored on an internal memory.

### FIELD OF THE INVENTION

This invention relates to the field of electronic RFID shelf labels. In particular, the invention relates to an improved system and method for interrogating and updating electronic UHF RFID shelf labels.

### BACKGROUND OF THE INVENTION

A typical Radio Frequency Identification (“RFID”) system consists of a plurality of RFID tags and an interrogator for reading the RFID tags to obtain data (e.g., pricing information, color, size, etc.) and/or update the information contained within the tags. Each RFID tag contains a transponder with a digital memory chip that is given a unique electronic product code. The interrogator, typically an antenna packaged with a transceiver and a decoder, emits a signal activating the RFID tag so information contained within the digital memory chip may be read/updated.

The RFID tags can either be active or passive. Passive RFID tags have no internal power supply and utilize the minute electrical current induced in the antenna by the incoming RF signal to transmit a response. Due to their limited power, passive RFID tags typically respond to an interrogation with just an ID number or product code.

In contrast, active RFID tags have an internal power source which enables them to have a longer read range and larger memories. However, active RFID tags eventually expire and are more expensive to produce than passive RFID tags.

Currently, there are four kinds of RFID tags in common use: low frequency tags (125 to 134.2 kHz), high frequency tags (13.56 MHz), UHF tags (868 to 856 MHz), and microwave tags (2.45 GHz). Each kind of RFID tag is suited to a different kind of application. For example, passive UHF tags, in particular, are well suited for use as electronic shelf labels because the tags are inexpensive to produce and can be scanned at distances as great as 30 feet.

Recently, there have been many attempts to create an electronic shelf label system which is capable of interrogating and/or updating the RFID tags located on products in a store in warehouse. Most systems have focused on providing an infrastructure to directly connect the electronic RFID tags to the central computer system. In these systems, a plurality of RFID monitoring devices are distributed throughout the store or warehouse in a manner such that every RFID tag in the store can be scanned. Each of the RFID monitoring devices is in communication with a central controller which is used to verify the information contained within each RFID tag. The connection between the RFID monitoring devices and the central controller may be either a wired or wireless connection.

In general, this infrastructure has been difficult to create without causing other problems in the environment, or has been simply too expensive. Accordingly, there exists a need for a system for monitoring electronic shelf labels which is both inexpensive and simple to deploy.

### SUMMARY OF THE INVENTION

In one exemplary embodiment of present invention, a system for interrogating and updating electronic shelf labels is provided. The system includes a plurality of products, wherein each product is equipped with an electronic shelf label and wherein each electronic shelf label stores information relating to the product, at lease one portable RFID device capable of scanning and updating the electronic shelf labels, a central controller which stores information about each of the products, and a wireless area network which allows for bi-directional communication between the portable RFID device and the central controller, wherein the information stored in the central controller is compared to the information stored in the electronic shelf labels as each electronic shelf label is scanned with the portable RFID device and wherein the portable RFID device updates the information stored in the electronic shelf label with the information from the central controller if the compared values are different.

The object of the present invention is to provide an electronic shelf tag system which is capable of interrogating and/or updating UHF RFID tags located within a store or warehouse using one or more RFID devices. The invention relies on the fact that UHF RFID tags can be reliably read at distances up to 30 feet by a simple battery-powered device. Instead of a fixed infrastructure for communications with the shelf tags, it is possible to have a portable device that will interrogate and update each of the electronic shelf tags. The scanning/updating functions may be performed by a store employee while engaged in other necessary activities, such as stocking shelves, organizing goods on the shelves (known as “leveling”), etc.

The portable RFID device may act as a bridge between a wireless LAN network so that the operation can be centrally controlled. Alternatively, the device could be self contained and have all the correct pricing information internally stored. In either case, a complete store wide verification and update can be performed in accordance with an exemplary embodiment of the present invention. Because the communication with the electronic shelf tag is bi-directional, it is possible to ensure that every tag in the store is interrogated and that it contains the correct information.

The foregoing objects, features, and advantages of the present invention will be apparent from the following detailed description of the preferred embodiments which makes reference to several drawing figures.

### BRIEF DESCRIPTION OF THE DRAWINGS

FIG. 1 depicts a schematic diagram showing the typical layout of a store or warehouse which is traversed by a worker carrying a portable RFID device;

FIG. 2 depicts a network diagram showing an exemplary network configuration for use with the present invention;

FIG. 3 depict a network diagram showing another exemplary network configuration for use with the present invention.

Throughout the Figures the same reference numerals and characters, unless otherwise stated, are used to denote like features, elements, components or portions of the illustrated embodiments. Moreover, while the present invention will now be described in detail with reference to the Figures, it is done so in connection with the illustrative embodiments.

### DETAILED DESCRIPTION OF THE INVENTION

In the following description of the preferred embodiments, reference is made to the accompanying figures which form the part thereof, and in which are shown by way of illustration of specific embodiments in which the invention may be practiced. It is to be understood that other embodiments may be utilized and structural and functional changes may be made without departing from the scope of the present invention.

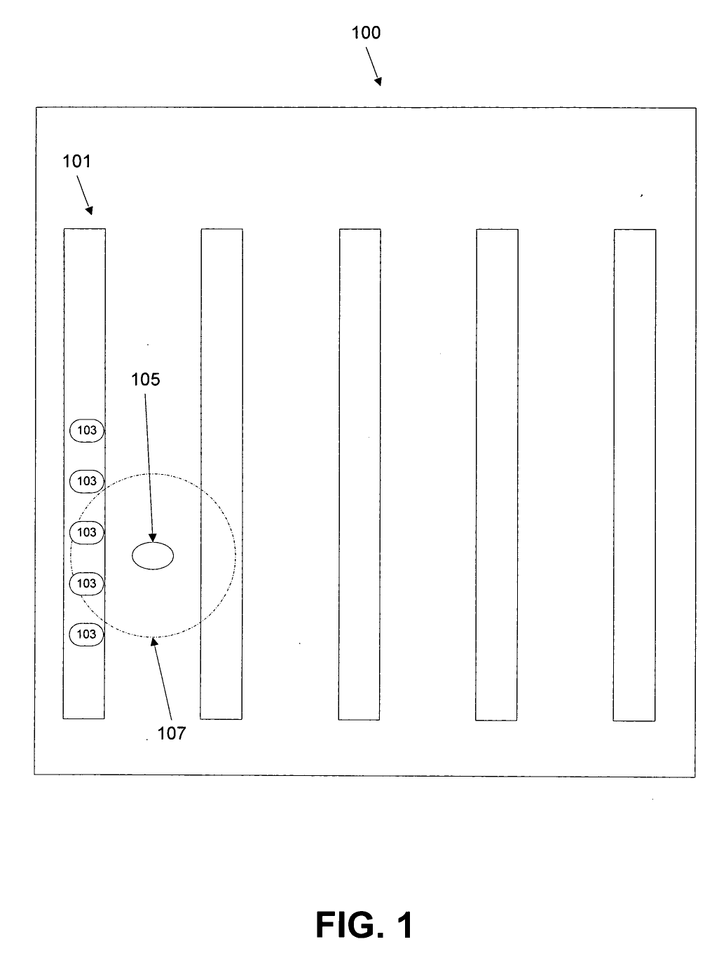

Referring first to FIG. 1, a schematic diagram is shown depicting the layout of shelves 101 in a typical store or warehouse. For convenience of the description herein, the layout of a typical store 100 will be utilized as an exemplary environment for deployment of an embodiment of the present invention. It will, however, be understood that the area of interest may be any area in which products (or items equipped with electronic shelf labels) are stored, moved or used (e.g. a transportation yard, retail store, a manufacturing plant, or other buildings or spaces). Each shelf 101 located in store 100 may contain a plurality of products 103 which are equipped with electronic shelf labels (not currently shown). In an exemplary embodiment of the present invention, the electronic shelf labels are UHF RFID tags which are encoded with the pricing information for each product 103.

Worker 105 who is typically an employee working within the store or warehouse, may carry a portable RFID device up and down the aisles of store 100 as he performs his normal daily duties, such as organizing the items located on shelves 101. The portable RFID device is preferably a battery-powered device which is capable of interrogating and/or updating the electronic shelf labels.

Circle 107 shows the scanning range of the portable RFID device. For example, if UHF RFID tags are utilized, circle 107 may have a radius as great as thirty feet. That is, the portable RFID device carried by worker 105 would be able to interrogated and/or update all UHF RFID tags located within a radius of thirty feet from worker 105. However, it should be obvious to one skilled in the art that more powerful portable RFID devices will eventually be manufactured, thus increasing the scanning range. Additionally, electronic shelf labels which have longer read distances may also be used in conjunction with the present invention.

As worker 105 traverses shelves 101, the electronic shelf labels located on products 103 within circle 107 are interrogated and/or updated by the RFID device. It should be obvious to one skilled in the art that multiple workers 105 could be equipped with portable RFID devices to increase the speed and/or number of times that each electronic shelf label is scanned or updated.

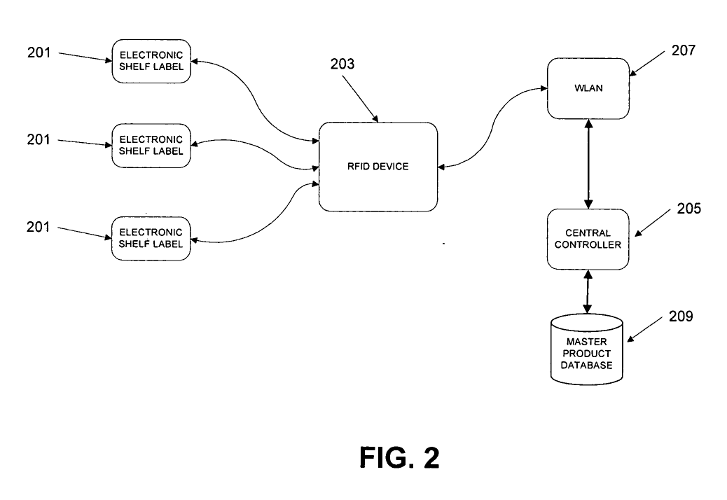

Referring next to FIG. 2, an exemplary network diagram is shown depicting an exemplary embodiment of the network by which each electronic shelf label 201 is interrogated and/or updated. As previously described, each electronic shelf label 201 (located on products 103) is scanned by portable RFID device 203 as worker 105 traverses the aisles of the store or warehouse. In this exemplary embodiment of the present invention, RFID device 203 may be in bi-directional communication with central controller 205 through wireless local area network (“WLAN”) 207. It should be obvious to one skilled in the art that WLAN 207 can be any type of wireless network capable of transmitting information reliably from RFID device 203 to central controller 205. For example, WLAN 207 may be an IEEE 802.11 network or a Bluetooth network. There are currently many portable RFID devices which are capable of communicating with both types of networks. However, the scope of the present invention is not limited to only these networks.

Central controller 205 is a preferably a server computer which contains master product database 209. Central controller 205 may either be located on-site or at a remote location. Master product database 209 preferably contains pricing information for each product 103 located in the store. However, it should be obvious to one skilled in the art that master product database 209 could contain any information about the different products 103 located in the store. For example, in an alternative embodiment, master product database 209 may contain information such as color, size, weight, expiration date, etc.

As each electronic shelf label 201 is interrogated by RFID device 203, its decoded value is sent to central controller 205 where it is compared with information store in master product database 209. In the event that the information in an electronic shelf label 201 and the master product database 209 is different, the central controller can send the correct information to RFID device 203 in order to update electronic shelf label 201. Thus, by utilizing the system of the present invention, a user only has to make changes to master product database 209 in order to update the information stored in all of the electronic shelf labels 201.

It should be obvious to one skilled in the art that the speed at which each electronic shelf label 201 is interrogated and updated can be accelerated by employing more than one RFID device 203. By increasing the number of RFID devices 203, the chance that any electronic shelf label 201 is missed is also reduced.

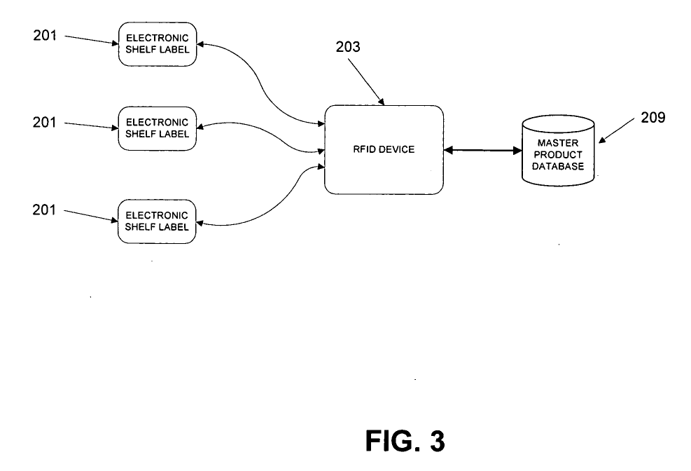

Now, referring to FIG. 3, shown is an alternate embodiment of the present invention in which master product database 209 is located directly on RFID device 203. In this exemplary embodiment, RFID device 203 may be completely self-contained and may include all of the necessary information from master product database 209 for interrogating and updating electronic shelf labels 201. This would eliminate the need for central controller 205 and WLAN 207 (as shown in FIG. 2). However, if more than one RFID device 203 is utilized in this alternate embodiment, the master product database 209 located on each device must be individually updated if any changes are made.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A system for interrogating and updating electronic shelf labels comprising:
a plurality of products, wherein each product is equipped with an electronic shelf label and wherein each electronic shelf label stores information relating to said product;
at lease one portable RFID device capable of scanning and updating said electronic shelf labels;
a central controller which stores information about each of said products;
a wireless area network which allows for bi-directional communication between said portable RFID device and said central controller;
wherein said information stored in said central controller is compared to said information stored in said electronic shelf labels as each electronic shelf label is scanned with said portable RFID device; and
wherein said portable RFID device updates the information stored in said electronic shelf label with the information from said central controller if the compared values are different.

2. The system of claim 1, wherein said products are located in a stored and wherein said portable RFID device is carried by a store employee.

3. The system of claim 2, wherein each of said electronic shelf labels located in said store is scanned as said worker traverses the aisles of the store.

4. The system of claim 1, wherein said electronic shelf labels are UHF RFID tags.

5. A system for interrogating and updating electronic shelf labels comprising:
a plurality of products, wherein each product is equipped with an electronic shelf label and wherein each electronic shelf label stores information about said product;
a portable RFID device capable of scanning and updating said electronic shelf labels;
a database stored on said portable RFID device which contains the correct information for each of said electronic shelf labels;
wherein said information stored in said database is compared to said information stored in said electronic shelf labels as each electronic shelf label is scanned with said portable RFID device; and
wherein said portable RFID device updates the information stored in said electronic shelf label with the information from database if the compared values are different.

6. The system of claim 5 wherein said products are located in a stored and wherein said portable RFID device is carried by a store employee and wherein each of said electronic shelf labels located in said store is scanned as said worker traverses the aisles of the store.

7. A method for interrogating and updating electronic shelf labels comprising the steps of:
equipping a store employee with a portable RFID decide capable of scanning all of the electronic shelf labels located in said store, wherein each electronic shelf label is affixed to a product and stores information about said product;
scanning at least one electronic shelf label within the range of said portable RFID device;
comparing the information from said at least one scanned electronic shelf label to information contained in a master product database, and
updating the information located in said electronic shelf label with the information from said master product database if the compared values are different.

8. The method of claim 7, wherein said master product database is located on said portable RFID device.

9. The method of claim 7, wherein said master database is located on a central controller and wherein said portable RFID device and said central controller are in bi-directional communication utilizing a wireless area network.

10. The method of claim 7, wherein said electronic shelf labels are UHF RFID tags.
